(19) United States
(12) Patent Application Publication
(10) Pub. No.: US 2009/0013116 A1
(43) Pub. Date: Jan. 8, 2009

(54) DATA COMMUNICATION METHOD, DATA TRANSMISSION AND RECEPTION DEVICE AND SYSTEM

(75) Inventors: Kark Oskar Svanell, Malmo (SE); Daniel J. Boijort, Jarfalla (SE); Atul Katoch, Kanata (CA)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/279,330

(22) PCT Filed: Feb. 6, 2007
(86) PCT No.: PCT/IB2007/050397

§ 371 Date: Aug. 13, 2008

(30) Foreign Application Priority Data
Feb. 13, 2006 (EP) 06101602.8

(51) Int. Cl. G06F 13/372

(52) U.S. Cl. 710/118

(57) ABSTRACT

A method (100) is disclosed for communicating data over a data communication bus (310) comprising a first conductor (312) and a set of further conductors (314). The method (300) comprises providing the first conductor (312) with a first signal transition (210) for signalling the start of a first data communication period (T1); and providing a further conductor (314), after a predefined delay with respect to the provision of the first signal transition (210), with a delayed signal transition (220), the predefined delay defining a first data value. Consequently, the method of the present invention provides a data encoding technique for data communication over a bus that requires less switching activity than other encoding techniques such as pulse width modulation encoding. The present invention further discloses a data communication device (400), a data reception device (500) and a system (300) including these devices, all implementing various aspects of the aforementioned method.

The present invention relates to a method for communicating data over a data communication bus comprising a first conductor and a set of further conductors;

the present invention further relates to a data transmission device for providing a data communication bus comprising a first conductor and a set of further conductors with data;

the present invention further relates to a data reception device for receiving data from a data communication bus comprising a first conductor and a set of further conductors; and

the present invention further relates to a system implementing the method for communicating data over a data communication bus comprising a first conductor and a set of further conductors.

The ongoing downscaling of semiconductor feature sizes such as feature sizes in CMOS processes facilitates the manufacture of future integrated circuits (ICs) that are smaller and have higher feature densities compared to contemporary ICs. This trend is a double-edged sword; it provides the opportunity for the generation of more complex ICs that may incorporate large systems on a single chip, but at the same time, it also causes more difficult design challenges.

Some of these challenges are in fact already relevant for the design of contemporary ICs. For instance, a present problem is how to ensure uncorrupted data communication between a data source and a data destination, e.g. data communication between two processing units over a data communication bus. The complexity of the IC can cause large volumes of data communication over the data communication bus, which manifests itself in high frequency switching behaviour on the bus. This switching behaviour can cause the (dis)charging of cross-coupling capacitances between neighbouring conductors of the bus, which has a detrimental impact on both the power consumption of the bus as well as on the propagation speed of the data over the bus conductors, which may cause data to be delayed to such an extent that it arrives outside a predefined time frame such as a clock cycle, causing the data to be lost. The magnitude of this problem increases exponentially with a reduction in distance between neighbouring bus conductors, and will therefore become even more relevant in future IC designs.

Various measures have already been disclosed to alleviate this problem, for instance measures in which the switching activity on the bus is reduced, such as bus invert encoding, or measures in which the number of required bus conductors is reduced, such as pulse width modulation (PWM) encoding, in which a multi-bit data value is encoded by a predefined pulse width on a single conductor. An example of such a technique is disclosed in U.S. Pat. No. 6,020,834, in which a multi-bit data value is encoded by a predefined delay between two successive edges of a pulse on the bus conductor.

However, a drawback of such a method is that for data values having a large number of bits, a large number of unique delays is required to be able to communicate every possible data value over the data communication bus. For instance, for a 16-bit data value, 2¹⁶ unique delays are required, which has a detrimental impact on the data communication speed. Hence, PWM is not particularly suitable for the efficient communication of large multi-bit data values. The efficiency may be improved by dividing a large multi-bit data value, e.g. a 16-bit value, into smaller portions, e.g. four portions of four bits, which are communicated in parallel over four different bus conductors. However, this increases the switching activity on the bus to eight signal transitions per sampling period in the given example, i.e. four pulses each having two edges, excluding the signal transitions of the synchronization signal such as a clock signal.

The present invention seeks to provide a method, data transmission device, data reception device and system of the opening paragraph that facilitate a more efficient way of communicating multi-bit data over a limited number of bus conductors.

According to a first aspect of the present invention, there is provided a method for communicating data over a data communication bus comprising a first conductor and a set of further conductors, the method comprising providing the first conductor with a first signal transition for signalling the start of a first data communication period; and providing a further conductor, after a predefined delay with respect to the provision of the first signal transition, with a delayed signal transition, the predefined delay defining a first data value. Because the method of the present invention only requires a single signal transition per bus conductor, the required switching activity of the method of the present invention is reduced compared to PWM encoding, especially when a plurality of further conductors in parallel are used for communicating parts of a data value in parallel.

The method may further comprise receiving the first signal transition from the first conductor; receiving the delayed signal transition from the further conductor; determining the delay between the first signal transition and the delayed signal transition; and determining the first data value from the determined delay to decode the one or more data values that have been provided to the data communication bus.

Advantageously, the first signal transition is an edge of a pulse having a predefined pulse width, said pulse width defining a second data value, the method further comprising providing the first conductor with the pulse; receiving the pulse from the first conductor; determining the width of the received pulse; and determining the second data value from the measured pulse width. This way, the first conductor can be used for both synchronisation as well as data communication, which facilitates a reduction of the total number of required bus conductors.

The method may further comprise providing the first conductor with a second signal transition for signalling the start of further data communication period; providing the further conductor with a further delayed signal transition, after a further predefined delay with respect to the provision of the second signal transition, the further predefined delay defining a third data value; receiving the second signal transition from the first conductor; receiving the further delayed signal transition from the further conductor; determining a further delay between the second signal transition and the further delayed signal transition; and determining the third data value from the determined further delay. This facilitates a further reduction of a signal transition: the further delayed signal transition may only be provided if the third data value differs from the first data value, wherein determining the third data value from the measured further delay comprises assigning the first data value to the third data value of no further delayed signal transition is received.

According to a further aspect of the invention, there is provided a data transmission device, comprising a first signal generator being arranged to provide a first signal transition for signalling the initiation of a first data communication period, the first signal generator having a first output for coupling to a first conductor of a data communication bus, and being responsive to an external signal; and a set of further signal generators responsive to the first signal generator, each further signal generator being arranged to provide, after a predefined delay respective to the provision of the first signal transition, a delayed signal transition from a plurality of delayed signal transitions, each delayed signal transition defining a respective data value from a plurality of data values; each further signal generator having a set of inputs for receiving a data value from the plurality of data values; and a set of further outputs for providing respective further conductors from a set of further conductors of the data communication bus with respective delayed signal transitions.

Such a data transmission device facilitates data encoding and transmission in accordance with the method of the present invention. Such a data transmission device may for instance be in the form of (a part of) an IC, or in the form of (a part of) an IP block for integration in an IC design.

Preferably, the first signal generator is coupled to the set of further signal generators via a delay line, the delay line being arranged to provide the plurality of delayed signal transitions. This provides a robust and low-power way of generating the delayed transitions requiring little or no switching activity, in contrast to a clock-based delay generator, which, however, may also be used.

In an exemplary embodiment, each further signal generator comprises selection means for selecting a delayed signal transition from the plurality of delayed signal transitions in response to the data value received on the set of inputs; a comparator for providing an output signal based on a comparison of the last received data value to the previously received data value; and logic for forwarding the selected delayed signal transition to the output in response to the comparator output signal. This provides an area-efficient implementation of a further signal generator.

Preferably, the first signal generator comprises a delay element coupled to its output for introducing a delay in the output of the first signal transition, said delay matching the processing time of the delayed signal transition by at least a part of the further signal generator. This ensures accurate synchronisation between the signal transitions on the first conductor and the delayed signal transitions on the further conductors. The required delay of the delay element may be determined during the design of the data transmission device; alternatively, the delay element may be programmable to facilitate post-manufacturing delay matching.

The first signal generator may be arranged to provide a pulse having a predefined pulse width, said pulse width defining a second data value, to allow the transmission of data over the first conductor of the data communication bus.

According to another aspect of the present invention, there is provided a data reception device, comprising a first input for receiving a first signal transition from a first conductor of a data communication bus; a set of further inputs for receiving from a set of further conductors of the data communication bus after a predefined delay with respect to the reception of the first signal transition, respective delayed signal transitions from a plurality of delayed signal transitions, each delayed signal transition defining a respective data value from a plurality of data values; a signal generator coupled to the first input for generating, after a predefined delay with respect to the reception of the first signal transition, a plurality of delayed further signal transitions, each delayed further signal transitions defining a respective data value from the plurality of data values; decoding means coupled to the set of further inputs and the signal generator for decoding the respective delayed signal transitions into the corresponding data values based on the plurality of delayed further signal transitions; and a set of outputs for receiving the decoded data values from the decoding means.

Such data reception device facilitates data reception and decoding in accordance with the method of the present invention. Such data reception device may for instance be in the form of (a part of) an IC, or in the form of (a part of) an IP block for integration in an IC design.

The decoding means may comprise signal transition detection means for detecting the respective delayed signal transitions; a set of registers, each coupled to the signal generator for capturing a delayed further signal transition in response to the signal detection means; and a set of decoding logic blocks, each coupled between a register from the set of register and a respective output for providing the output with a data value from the range of values based on the delayed further signal transition captured by the register.

This provides an area efficient and scalable implementation, in which the transition detection means may be implemented as one or more edge detectors.

Preferably, the signal generator comprises a delay chain comprising a plurality of delay elements, each delay element comprising an output for generating a delayed further signal transition from the plurality of delayed further signal transitions. This facilitates a robust and low-power way of generating the delayed signal transitions, as previously explained.

The delay elements may comprise a plurality of shunt capacitors responsive to respective control signals to provide a programmable delay chain, which facilitates the matching of the delays of the delay chain to the delays generated by data transmission device at an opposite end of a data communication bus, to ensure correct interpretation of the received encoded signals. Moreover, additional delay introduced by the data communication bus may also be compensated for. Other implementations of a programmable delay chain are also feasible, but the shunt capacitor based implementation is preferred for reasons of power consumption and robustness. The shunt capacitors may have different widths, i.e. different capacitances, to facilitate a fine-grained tuning of the delay.

To this end, the data reception device may further comprise a calibration circuit for generating the set of control signals, the calibration circuit comprising a control block being arranged to receive the first signal transition, a delayed signal transition and a corresponding delayed further signal transition, the control block being responsive to a calibration signal; a control signal generator for providing the respective control signals, the control signal generator being responsive to the calibration signal; a first register coupled to control signal generator for receiving a first set of control signals; a second register coupled to control signal generator for receiving a second set of control signals, the first and second register being responsive to the control block; and a mean value block coupled to the first register and the second register for determining mean value control signals from the first set of control signals and the second set of control signals, the mean value block having a set of outputs coupled to the plurality of shunt capacitors for providing the shunt capacitors with a mean value of the first and second set of control signals.

This facilitates a calibration of the delay chain by finding the outer boundaries of a window in which a delayed signal transition from a selected delay element of the delay chain is correctly interpreted, and selecting a delay setting for the delay chain elements in the middle of this window, thus providing maximum tolerances for variations in the delay of signal transitions such as variations introduced by cross-coupling interferences between neighbouring bus conductors.

According to a further aspect of the invention, there is provided a system comprising a data transmission device and a data reception device of the present invention, and a data communication bus comprising a first conductor coupled between the first output of the data transmission device and the first input of the data reception device; and a set of further conductors coupled between the set of further outputs of the data transmission device and the set of further inputs of the data reception device.

Such a system implements the method of the present invention, and benefits from the same advantages as mentioned for said method. The system may be a system-on-chip, with the data transmission device and the data reception device located on the same IC. Alternatively, the system may include a multitude of ICs, with the data transmission device and the data reception device residing on different integrated circuits, and wherein the data communication bus is at least partly located on a carrier of the different integrated circuits. The system typically is a (part of a) data processing system for processing binary data, such as a digital electronic device, e.g. a computer, an audio signal processing device, video signal processing device, mobile communications device and so on.

The invention is described in more detail and by way of non-limiting examples with reference to the accompanying drawings, wherein:

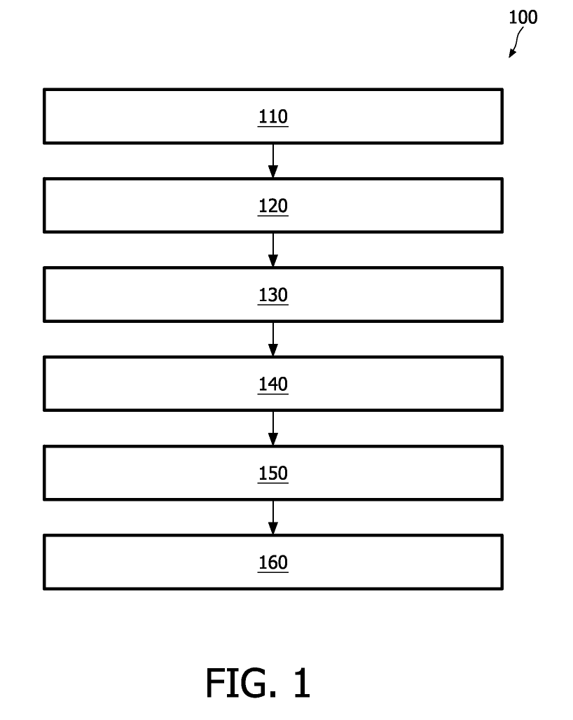

FIG. 1 depicts a flowchart of an embodiment of the method of the present invention;

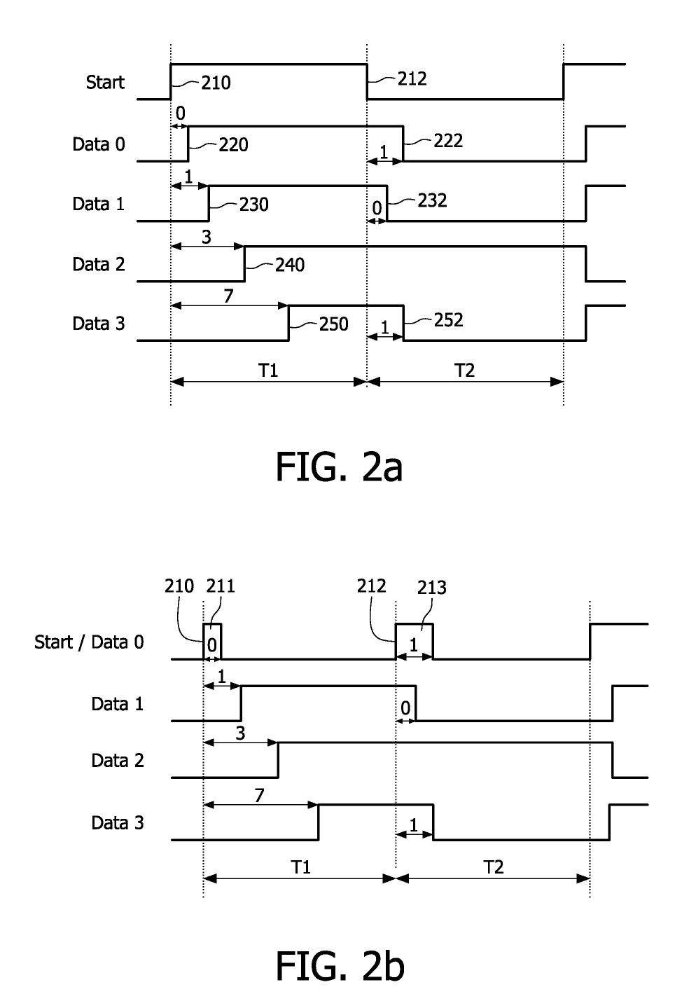

FIG. 2a depicts a timing diagram of signal transitions according to an embodiment of the method of the present invention;

FIG. 2b depicts another timing diagram of signal transitions according to another embodiment of the method of the present invention;

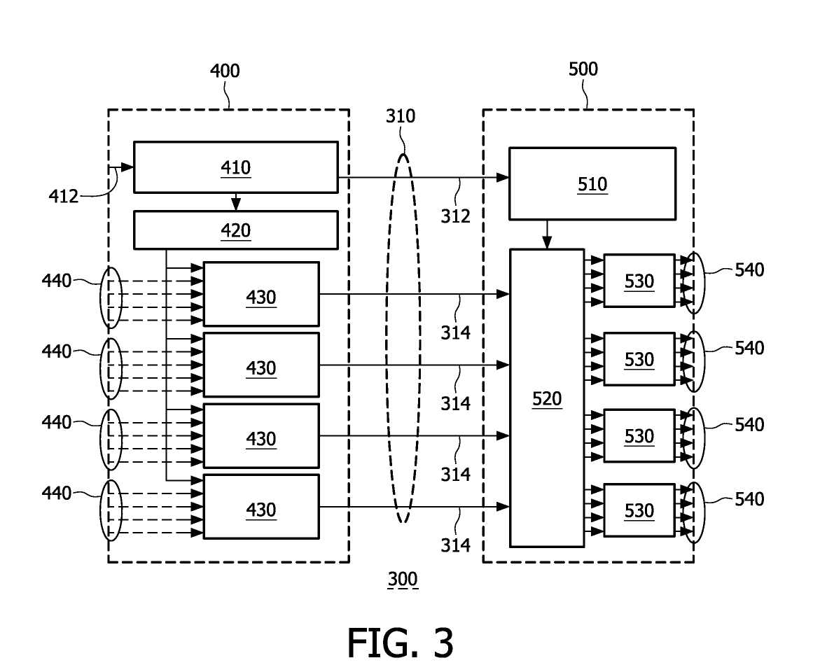

FIG. 3 depicts an embodiment of a system of the present invention;

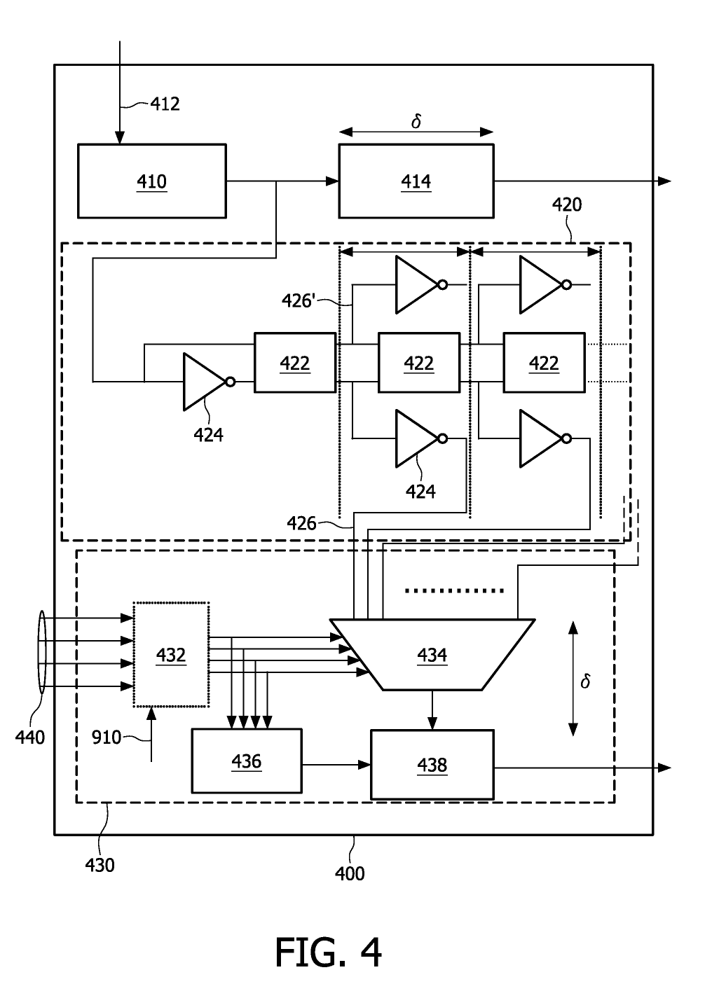

FIG. 4 shows an embodiment of a data transmission device of the present invention;

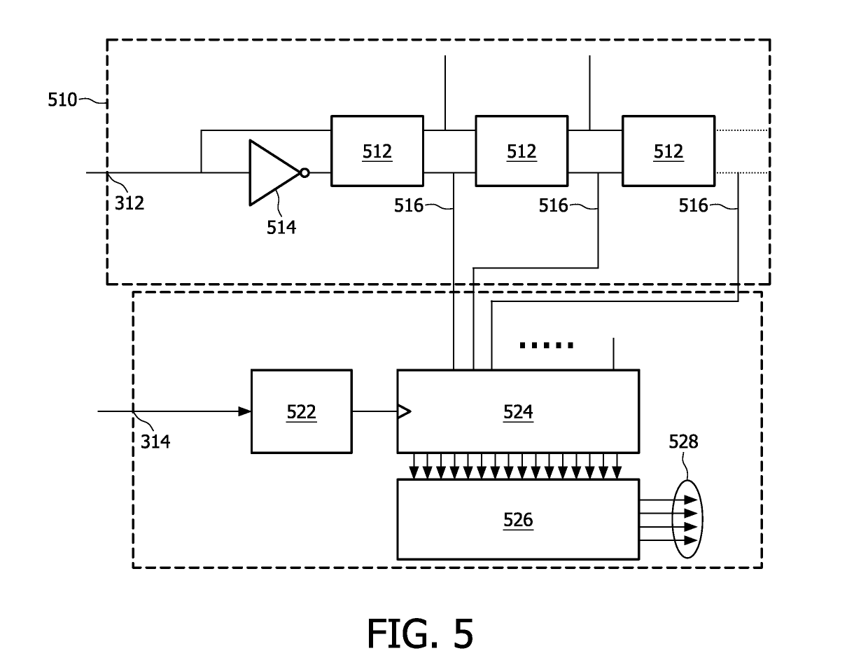

FIG. 5 shows a detail of an embodiment of a data reception device of the present invention;

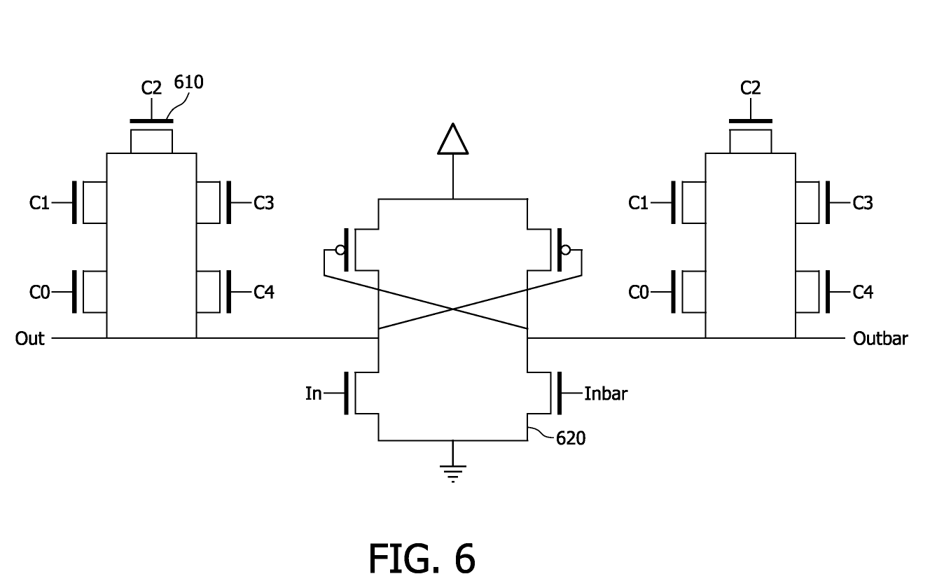

FIG. 6 shows another detail of an embodiment of a data reception device of the present invention;

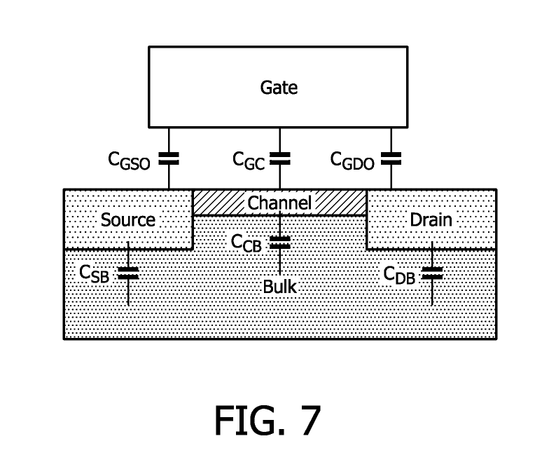

FIG. 7 schematically depicts the capacitances present in an nMOS device;

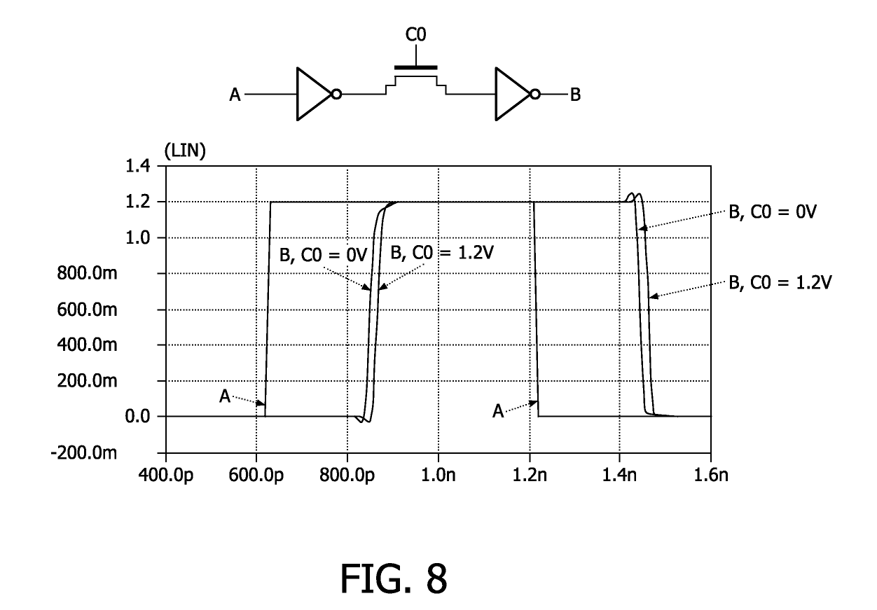

FIG. 8 shows a graph depicting a programmable delay; and

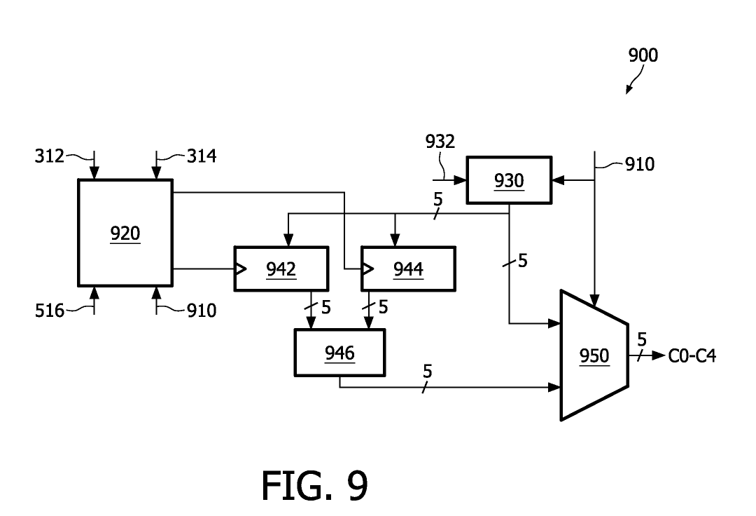

FIG. 9 shows yet another detail of an embodiment of a data reception device of the present invention.

It should be understood that the Figures are merely schematic and are not drawn to scale. It should also be understood that the same reference numerals are used throughout the Figures to indicate the same or similar parts.

FIG. 1 is a flowchart of a method 100 of the present invention for communicating data over a data communication bus. In a first step 110, a first conductor of the bus is provided with a first signal transition for signalling the start of a first data communication period. This first signal transition typically is an edge of a signal pulse, and serves as a start signal for the data communication. The first data communication period may be a clock cycle, or a period initiated by an asynchronous data communication request, e.g. a handshake signal.

Next, in step 120, a further conductor of the bus is provided with a further signal transition that is delayed with respect to the first signal transition. This delay is one of a number of predefined delays that define the various data values in a range of data values to be communicated over the bus. The bus may have an integer number N of further conductors that each transmit such a delayed signal transition, thus facilitating the transmission of N different data values per provided first signal transition over a total of N+1 conductors.

Alternatively, the first conductor of the bus may also be used to communicate a data value, by confining the signal pulse of which the first signal transition is a part to the first data communication period and giving the pulse a predefined pulse width that can be interpreted as another data value from the aforementioned range of data values. This is a known implementation of PWM encoding, such as disclosed in U.S. Pat. No. 6,020,834, and does not need to be further discussed for this reason.

Next, in step 130, the first signal transition is received from the first conductor on the receiver end of the bus, which signals the start of the reception of encoded data values on the N further conductors, and if the first signal transition is part of a PWM encoded pulse, of the reception of an encoded data value of the first conductor. Subsequently, in step 140, the various delayed signal transitions are received from the N further conductors, and in step 150, the delay between the received first signal transition and the received delayed signal transitions is determined, and the respective data values as encoded by the delayed signal transitions are determined from the determined respective delays in step 160. These steps may be repeated in further data communication periods.

A further reduction in required signal transitions for communicating data over the data communication bus can be achieved by not providing a signal transition to a further conductor in a subsequent data communication period if the data value to be communicated in that period is identical to the previously communicated data value. Thus, the receiving end of the data communication bus will reassign the previously decoded data value to the subsequent data communication period in step 160 if no delayed signal transition is received in that period.

FIG. 2a depicts a timing diagram of an example of the data communication method of the present invention over a bus having a first conductor labelled ‘Start’, and four further conductors labelled ‘Data 0’, ‘Data 1’, ‘Data 2’ and ‘Data 3’ respectively. In the first data communication period T1, a first signal transition 210, e.g. an edge of a pulse, is provided to the ‘Start’ conductor. The further conductor ‘Data 0’ is provided with a signal transition 220 that is delayed with respect to the first signal transition 210. The amount of delay encodes a numeric data value ‘0’. The further conductor ‘Data 1’ is provided with a signal transition 230 that is also delayed with respect to the first signal transition 210. This amount of delay encodes a numeric data value ‘1’. The further conductor ‘Data 2’ is provided with a signal transition 240 that is also delayed with respect to the first signal transition 210. This amount of delay encodes a numeric data value ‘3’. Finally, the further conductor ‘Data 3’ is provided with a signal transition 250 that is also delayed with respect to the first signal transition 210. This amount of delay encodes a numeric data value ‘7’.

It will be obvious that the encoded data values are presented as numeric values by way of non-limiting example only and that binary representations of the data values are equally feasible.

In the second data communication period T2, the ‘Start’ conductor is provided with signal transition 212, which in FIG. 2a is a trailing edge of a pulse of which first signal transition 210 is the leading edge. This pulse may be part of a regular pulse train, e.g. a clock signal. The further conductor ‘Data 0’ is provided with a signal transition 222 that is delayed with respect to the signal transition 212, the delay encoding the data value ‘1’. The further conductor ‘Data 1’ is provided with a signal transition 232 that is delayed with respect to the signal transition 212, the delay encoding the data value ‘0’, and the further conductor ‘Data 3’ is provided with a signal transition 252 that is also delayed with respect to the signal transition 212, the delay encoding the data value ‘1’.

The further conductor ‘Data 2’ is not provided with a signal transition in T2. The receiving end of this conductor will interpret the absence of a signal transition as communication of the same data value, as communicated in the previous data communication period, i.e. data value ‘3’ communicated in T1.

In FIG. 2b, the first conductor ‘Start’ is not only used to signal the initialization of a data communication period, but is also used to communicate data over the data communication bus. The signal transitions 210 and 212 that signal the start of the respective data communication periods T1 and T2 now belong to different pulses, i.e. pulse 211 and pulse 213 respectively, with each pulse having a pulse width that is smaller than the data communication period. The respective pulse widths of pulses 211 and 213 correspond to encoded data values, i.e. value ‘0’ and ‘1’ respectively, in analogy with PWM encoding. This obviates the need for a conductor dedicated to the provision of data communication initialization signals only.

FIG. 3 schematically depicts a system 300 of the present invention. The system 100 has a data transmission device 400 and a data reception device 500 coupled to a data communication bus 320, which has a first conductor 312 and a set of further conductors 314. In the context of the present invention, a set is intended to contain one or more members. The bus 310 may be implemented using known techniques. For instance, neighbouring conductors of the bus 310 may have delay elements on opposite ends (i.e. the transmission end and the reception end) of the bus to avoid simultaneous switching at two neighbouring conductors while in the mean time ensuring that the amount of delay experienced on each conductor is more or less identical, and the conductors may comprise a number of drivers to ensure that an appropriate signal integrity is maintained.

The data transmission device 400 has a module 410 for generating the initialization signal transitions on the conductor 312, i.e. signal transitions 210 and 212. The module 410 is responsive to a data communication request signal provided on its input 412. This may be a clock signal in case of continuous data transfer over the data communication bus 310. An output of the module 410 is coupled to a delay generator 420, e.g. a delay chain, for generating a set of delayed signal transitions, each signal transition corresponding to a different encoded data value from the range of data values that may be communicated over the bus 310, such that the set of delayed signal transitions covers each value in the data value range.

The delay generator 420 is coupled to a number of encoders 430, each encoder 430 being responsive to the module 410, and being coupled between a further conductor 314 and an integer number M of inputs 440 for receiving an M-bit data value. Each encoder 430 is configured to select one of the delayed signal transitions from the delay generator 420 based on the received M-bit input, and to output the delayed signal transition onto its further conductor 314.

The data reception device 500 has a delay generator 510 coupled to the first conductor 312. The delay generator 510 is arranged to generate the set of delayed signal transitions, similar to delay generator 420 from a signal transition received from the first conductor 312. The delayed signal transitions are forwarded to a decoder 520. The decoder 520 is arranged to decode each delayed signal transition received from the further conductors 314 based on a comparison or matching of the delayed signal transition received from a further conductor 314 and the set of delayed signal transitions received from the delay generator 510. The decoder 520 is further arranged to output the decoded M-bit values either directly to respective outputs 540 or to optional registers 530, in case the respective outputs 540 should receive the decoded data values in a synchronized fashion. The decoder 520 may comprise a number of subunits (not shown), each configured to decode the encoded data value received from a subset of further conductor, e.g. from a single further conductor.

FIG. 4 shows an embodiment of the data transmission device 400 in greater detail. The module 410 comprises a flip-flop triggered by a clock signal 412 for generating the first signal transition. The module 410 has an output for providing a first conductor of a data communication bus with the first signal transition; this output may comprise a delay element 414 to match a processing delay δ introduced in another part of the data transmission device 400 (vide infra). The module 410 is also coupled to the delay generator 420, which is implemented as a delay chain having a plurality of delay elements 422. Each delay element is arranged to generate a delayed signal transition that corresponds to one of the data values from the range of data values that can be encoded by the data transmission device 400. Each delay element 422 has a number of outputs 426 to provide a corresponding number of encoders 430 with its delayed signal transition.

The delay elements 422 may be implemented using known implementations of such elements. A suitable implementation can be achieved by the use of differential cascade voltage switch logic gates, because such gates provide a robust and low-power implementation. It is known that for such gates the falling edge is faster than the rising edge; this may be compensated by implementing each delay element 422 in duplo, with one element being the logic complement of the other. This is shown in FIG. 4 by the two inputs to the first delay element 422, with one input including an inverter 424 to provide the logic complement of the other input. This is by way of example only; other delay element implementations that for instance receive a single input are equally feasible. The outputs 426 of the delay elements 422 may comprise a load element such as an inverter 424 to stabilize the load on the outputs 426.

The outputs 426 are provided to an encoder 430, which is arranged to receive an n-bit data value, e.g. a data word, via its inputs 440 and to encode this n-bit data value into a predefined delayed signal transition. To this end, the encoder 430 comprises an input logic block 432 coupled between the inputs 440 and the control terminal of a multiplexer (MUX) 434. The signal inputs of the MUX 434 are the various outputs 426 of the delay elements 422 such that each encoded data value from the range of data values can be selected. The input logic block 432 is configured to select the appropriate input of the MUX 432 in response to a data value received via the inputs 440. The input logic block is also responsive to a calibration signal 910 for calibrating the data communication over a system 300. This will be explained in more detail later.

The output of the MUX 434 is coupled to an output (not shown) of the data communication device 400 to facilitate the provision of a selected delayed signal transition to a further conductor of a data communication bus. It is possible that the MUX 432 introduces a delay 6 into the forwarding of a delayed signal transition from a delay element output 426 to its own output. This delay should be matched in the generation of the first signal transition by module 410, for instance by the optional delay element 414. The delay may be determined during the design of the data transmission device 400. Alternatively, the delay element 414 may be programmable to facilitate the determination of δ after manufacturing.

The encoder 430 may comprise a comparator 436 coupled to the outputs of the input logic block 432 for comparing a data value received in the previous data transmission period with the data value received in the current data value, to prevent the MUX 434 from forwarding a delayed signal transition to the output of the data transmission device 400 in case the compared data values are the same. To this end, bypass logic 438 under control of the comparator 436 is placed between the output of the MUX 434 and the output of the data communication device 400.

FIG. 5 shows an embodiment of a data reception device 500 of the present invention. A delay chain 510 is arranged to receive a first signal transition from a first conductor 314 of a data communication bus 310. The delay chain has a number of delay elements 514 each arranged to generate a delayed signal transition that corresponds to one of the data values from the range of data values as encoded by a data transmission device 400, and to provide these delayed signal transitions to their outputs 516.

The data reception device 500 further comprises a decoder 520, which includes a signal transition detector 522, e.g. a pulse edge detector, for detecting a delayed signal transition from a further conductor 314 of the data communication bus 310. The detector 522 has an output coupled to a register 524 for capturing the delayed signal transitions from outputs 516. The register 524 is coupled to decoding logic 526, which is arranged to decode the delayed signal transitions captured by the register 524 into to the n-bit data value received by the data transmission device 400 on its corresponding inputs 440. The decoded data value is provided either directly to the corresponding outputs 540 of the data reception device 500 or to the corresponding register 530, as previously explained.

At this point, it is emphasized that a data communication device 400 and a data reception device 500 may also be a part of an IC module to facilitate two-way encoded communication between the IC module and an external device, e.g. another IC module of a SoC or another IC on a printed circuit board.

FIG. 6 shows a preferred embodiment of a part of a delay element 512 in more detail. A differential cascade voltage logic switch block 620 has its input (In) and complementary input (Inbar) coupled to an input (not shown) for receiving the first signal transition from first conductor 312, and has its output (Out) and complementary output (Outbar) coupled to a respective set of shunt capacitors 610. Each shunt capacitor 610 is controlled by one of the control signals C0-C4. The shunt capacitors 610 have different widths to facilitate the programming of different delays by the control signals C0-C4. It will be appreciated that the choice of ten shunt capacitors 610 controlled by five different control signals is by way of non-limiting example only; other numbers of shunt capacitors 610 controlled by other numbers of control signals are equally feasible.

The principle of how the capacitance of a transistor-implemented shunt capacitor 610 can be tuned is explained with the aid of FIG. 7. The total drain-source capacitance is dependent on the operation mode of the transistor. For the sake of simplicity, the reasoning in this section will only be presented for an NMOS transistor. When the transistor is operating in the cut-off region, the capacitances C_{GC} and C_{CB} will not be present, and the only capacitances are the overlap capacitances from drain and source to gate (C_{GDO} and C_{GSO} respectively) and the bulk capacitances (C_{SB} and C_{DB}). If the transistor operates in resistive or saturation mode, however, the capacitances between the channel and gate (C_{GC}) and the channel and bulk (C_{CB}) appear. The various operation modes of the transistor exhibit the following respective capacitances:

C_{cut-off}=C_{GSO}+C_{GDO}+C_{SB}+C_{DB}

Cₗᵢₙₑₐᵣ=C_{GSO}+C_{GDO}+C_{SB}+C_{DB}+(C_{GC}+C_{CB})

C_{Saturation}=C_{GSO}+C_{GDO}+C_{SB}+C_{DB}+⅔(C_{GC}+C_{CB}),

with C_{cut-off} being the total cut-off capacitance, Cₗᵢₙₑₐᵣ being the total linear capacitance and Cₛₐₜᵤᵣₐₜᵢₒₙ being the total saturation capacitance.

If both drain and source are connected to the same net, controlling which region the transistor operates in can be used to vary the capacitance and thereby also the delay of that net. Since V_{DS}=0, this can be done by simply changing the gate potential. When a high (1.2V) voltage is applied on the gate, the capacitance increases, and when a low voltage (0V) is applied, the capacitance decreases. This is an easy way to fine-tune the delay in a circuit. Since source and drain are connected, the transistor will always be in either the cut-off or linear region.

The programmability of the delay of a shunt capacitor 610 is shown in FIG. 8. For a shunt capacitor 610 having an input A, an output B and a control terminal C0, it is demonstrated that the application of a higher voltage (1.2V) on the control terminal C0 increases the delay of the shunt capacitor 610 with respect to the application of a lower voltage (0V) on the control terminal C0. Hence, the delay of a delay element 512 can be selected by providing the appropriate shunt capacitors 610 with the appropriate selection signals. The difference in delay is capacitance dependent; a larger capacitance, i.e. a larger shunt capacitor, facilitates larger differences in delay.

At this point, it is emphasized that other implementations of a delay elements 512 are also feasible; in fact, any known implementation of such a delay element may be used, although care has to be taken that an acceptable accuracy and signal integrity is achieved. For this reason, the shunt-capacitor based implementation is preferred, since this implementation provides these requirements without the need for considerable design efforts.

FIG. 9 shows an embodiment of a calibration circuit 900 for generating the control signals C0-C4. The calibration circuit 900 has a control block 920 that is responsive to an external calibration signal 910, which may be generated by a calibration controller (not shown) of the system 300, for instance at system start-up. The control block 920 is arranged to receive a signal transition from the first conductor 312 and a delayed signal transition from a preselected further conductor 314 of the data communication bus 310, as well as the delayed signal transition from the output 516 of a delay element 512 that is arranged to generate the delayed signal transition that corresponds to the delayed signal transition from the preselected further conductor 314. A signal generator 930, which may be implemented as a counter, is also responsive to the calibration signal 910, and may be reset by a reset signal 932, which may also be provided by the calibration controller.

The calibration circuit 910 further comprises a first register 942 and a second register 944 under control of the control block 920. The first register 942 and the second register 944 have their inputs coupled to the signal generator 930 and have their outputs coupled to a mean value generator 946, which is arranged to calculate the average of the values stored in these registers. The values stored in these registers are control signal values for controlling the shunt capacitors 610 as previously explained. A MUX 950 under control of the calibration signal 910 is arranged to receive a first set of control signal values from the signal generator 930 and a second set of control signal values from the mean value generator 946, and is arranged to provide the shunt capacitors 610 with one of these sets of values.

The calibration circuit 900 operates in a following manner. In calibration mode, the data transmission device 400, which is responsive to the calibration signal 910, will be forced to repeatedly transmit a first signal transition over the first conductor 312 and a preselected encoded data value, for instance an encoded decimal value ‘14’, over the further conductor 314 that is coupled to the control block 920. Simultaneously, the control signal generator 930 will step through all possible control signal settings to vary the delay of the delay elements 512 by varying the capacitances of shunt capacitors 610, as previously explained. The MUX 950 is arranged to select the control values from the control signal generator 930 when the calibration signal 910 is active, which means that the shunt capacitors 610 are subjected to the varying control signals from the control signal generator 930.

The control block 920 compares the delayed signal transition from the output 516 with the signal transition from the further conductor 314. The first time that the control block 920 evaluates these transitions as belonging to the same encoded data value, the first register 942 is triggered to sample the actual control signal values from the control signal generator 930. Subsequently, the second register 944 samples the actual control values signal of the control signal generator 930 as long as the control block 920 decides that the data values received from the further conductor 314 and the delay element output 516 are identical. Consequently, the first register 342 and the second register 344 contain the boundaries of an interval, corresponding to a minimum delay value and a maximum delay value generated by the delay element 512, in which the control values of the control signal generator 930 cause the generation of a delay that leads to the correct decoding of the delayed signal transition received on the further conductor 314.

The mean of these two control signal values, labelled R1 and R2, is calculated by a (R1+R2)/2 operation that is implemented by the mean value generator 946. Upon completion of the calibration, the calibration signal 910 is deactivated, and the MUX 950 will output the control signal values from the mean value generator 946 to the shunt capacitors 610 of the delay line 510. Because these control signal values lie in the middle of the aforementioned interval, they ensure that the operation of the data reception device 500 is insensitive to delay variations in the delayed signal transitions, as long as these variations do not exceed half the delay period of the interval obtained in calibration mode. The calibration circuit 900 may be a part of the data reception device 500, or may be placed external thereto in a system 300.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method for communicating data over a data communication bus comprising a first conductor and a set of further conductors, comprising:
providing the first conductor with a first signal transition for signalling the start of a first data communication period; and
providing a further conductor, after a predefined delay with respect to the provision of the first signal transition, with a delayed signal transition, the predefined delay defining a first data value.

2. A method as claimed in claim 1, further comprising:
receiving the first signal transition from the first conductor;
receiving the delayed signal transition from the further conductor;
determining the delay between the first signal transition and the delayed signal transition; and
determining the first data value from the determined delay.

3. A method as claimed in claim 1, wherein the first signal transition is an edge of a pulse having a predefined pulse width, said pulse width defining a second data value, the method further comprising:
providing the first conductor with the pulse;
receiving the pulse from the first conductor;
determining the width of the received pulse; and
determining the second data value from the measured pulse width.

4. A method as claimed in claim 1, comprising:
providing the first conductor with a second signal transition for signalling the start of further data communication period;
providing the further conductor with a further delayed signal transition, after a further predefined delay with respect to the provision of the second signal transitions, the further predefined delay defining a third data value;
receiving the second signal transition from the first conductor;
receiving the further delayed signal transition from the further conductor;
determining a further delay between the second signal transition and the further delayed signal transition; and
determining the third data value from the measured further delay.

5. A method as claimed in claim 4, wherein said further delayed signal transition is provided if the third data value differs from the first data value, and wherein determining the third data value from the determined further delay comprises assigning the first data value to the third data value of no further delayed signal transition is received.

6. Data transmission device, comprising:
a first signal generator being arranged to provide a first signal transition for signalling the initiation of a first data communication period, the first signal generator having a first output for coupling to a first conductor of a data communication bus, and being responsive to an external signal; and
a set of further signal generators responsive to the first signal generator, each further signal generator being arranged to provide, after a predefined delay respective to the provision of the first signal transition, a delayed signal transition from a plurality of delayed signal transitions, each delayed signal transition defining a respective data value from a plurality of data values; each further signal generator having:
a set of inputs for receiving a data value from the plurality of data values; and
a set of further outputs for providing respective further conductors from a set of further conductors of the data communication bus with respective delayed signal transitions.

7. Data transmission device as claimed in claim 6, wherein the first signal generator is coupled to the set of further signal generators via a delay line, the delay line being arranged to provide the plurality of delayed signal transitions.

8. Data transmission device as claimed in claim 6, wherein each further signal generator comprises:
selection means for selecting a delayed signal transition from the plurality of delayed signal transitions in response to the data value received on the set of inputs;
a comparator for providing an output signal based on a comparison of the last received data value to the previously received data value; and
logic for forwarding the selected delayed signal transition to the output in response to the comparator output signal.

9. Data transmission device as claimed in claim 8, wherein the first signal generator comprises a delay element coupled to its output for introducing a delay in the output of the first signal transition, said delay matching the processing time of the delayed signal transition by at least a part of the further signal generator.

10. Data transmission device as claimed in claim 6, wherein the first signal generator is arranged to provide a pulse having a predefined pulse width, said pulse width defining a second data value.

11. A data reception device, comprising:
a first input for receiving a first signal transition from a first conductor of a data communication bus;
a set of further inputs for receiving, from a set of further conductors of the data communication bus after a predefined delay with respect to the reception of the first signal transitions, respective delayed signal transitions, from a plurality of delayed signal transitions, each delayed signal transition defining a respective data value from a plurality of data values;
a signal generator coupled to the first input for generating, after a predefined delay with respect to the reception of the first signal transition, a plurality of delayed further signal transitions, each delayed further signal transitions defining a respective data value from the plurality of data values;
decoding means coupled to the set of further inputs and the signal generator for decoding the respective delayed signal transitions into the corresponding data values based on the plurality of delayed further signal transitions; and
a set of outputs for receiving the decoded data values from the decoding means.

12. A data reception device as claimed in claim 11, wherein the decoding means comprise:
signal transition detection means for detecting the respective delayed signal transitions;
a set of registers, each coupled to the signal generator for capturing a delayed further signal transition in response to the signal detection means; and
a set of decoding logic blocks, each coupled between a register from the set of registers and a respective output for providing the output with a data value from the range of values based on the delayed further signal transition captured by the register.

13. Data reception device as claimed in claim 11, wherein the signal generator comprises a delay chain comprising a plurality of delay elements, each delay element comprising an output for generating a delayed further signal transition from the plurality of delayed further signal transitions.

14. Data reception device as claimed in claim 13, wherein each delay element is programmable by a set of control signals.

15. Data reception device as claimed in claim 14, wherein each delay element comprises a plurality of shunt capacitors, each shunt capacitor being responsive to a control signal from the set of control signals.

16. Data reception device as claimed in claim 15, wherein each shunt capacitor has a different capacitance.

17. Data reception device as claimed in claim 14, further comprising a calibration circuit for generating the set of control signals, the calibration circuit comprising:
a control block being arranged to receive the first signal transition, a delayed signal transition and a corresponding delayed further signal transition, the control block being responsive to a calibration signal;
a control signal generator for providing the respective control signals, the control signal generator being responsive to the calibration signal;
a first register coupled to control signal generator for receiving a first set of control signals;
a second register coupled to control signal generator for receiving a second set of control signals, the first and second register being responsive to the control block;
a mean value block coupled to the first register and the second register for determining mean value control signals from the first set of control signals and the second set of control signals, the mean value block having a set of outputs coupled to the plurality of shunt capacitors for providing the shunt capacitors with a mean value of the first and second set of control signals.

18. A system comprising:
a data transmission device as claimed in claim 6;
a data reception device as claimed in claim 11; and
a data communication bus comprising:
a first conductor coupled between the first output of the data transmission device and the first input of the data reception device; and
a set of further conductors coupled between the set of further outputs of the data transmission device and the set of further inputs of the data reception device.

19. A system as claimed in claim 18, wherein the system is located on a single integrated circuit.

20. A system as claimed in claim 18, wherein the data transmission device and the data reception device reside on different integrated circuits, and wherein the data communication bus is at least partly located on a carrier of the different integrated circuits.

21. Integrated circuit module for communicating data over a data communication bus in accordance with the method as claimed in claim 1, the integrated circuit module comprising:
data transmission device as claimed in claim 6 for transmitting data to said bus; and
data reception device as claimed in claim 11 for receiving data from said bus.
